(19) United States
(12) Patent Application Publication
(10) Pub. No.: US 2016/0096260 A1
(43) Pub. Date: Apr. 7, 2016

(54) METHODS AND APPARATUS FOR EXPELLING A PROJECTILE

(71) Applicant: QINETIQ LIMITED, Farnborough Hampshire (GB)

(72) Inventor: Kenneth Andrew PINK, Fareham, Hampshire (GB)

(21) Appl. No.: 14/889,297

(22) PCT Filed: May 13, 2014
(86) PCT No.: PCT/EP2014/059794

§ 371 Date: Nov. 5, 2015

(30) Foreign Application Priority Data
May 13, 2013 (GB) 1308564.2

(51) Int. Cl. B25C 1/14

(52) U.S. Cl. CPC B25C 1/146

(57) ABSTRACT

Some embodiments are directed to a tool arranged to at least partially expel a projectile. The tool includes a housing having a primary axis, and, at least partially enclosed within the housing, a firing mechanism and a projectile arranged to be at least partially expelled from the housing in a direction parallel to the primary axis on actuation of the firing mechanism. The firing mechanism includes a chemical propellant and at least two moveable components, both of the components being moveable in a direction parallel to the primary axis within the housing. The chemical propellant is arranged such that, when activated, the gases created thereby act to expel the projectile, and the moveable components are arranged such that displacement of both components from a rest position is required to activate the propellant, and the components are moveable in response to a force applied directly along the primary axis.

### CROSS REFERENCE TO RELATED APPLICATIONS

This application is a National Phase filing under 35 C.F.R. §371 of and claims priority to International Application No. PCT/EP2014/059794, filed on May 13, 2014, which claims the priority benefit under 35 U.S.C. §119 of British Patent Application No. 1308564.2 filed on May 13, 2013, the contents of which are hereby incorporated in their entireties by reference.

### FIELD OF THE INVENTION

The present invention relates to a tool arranged to at least partially expel a projectile. This could be propelled into a substrate to provide a fastening or a stopper. In particular but not exclusively, the tool is a powder cartridge actuated tool.

### BACKGROUND TO THE INVENTION

A class of tools known as ‘powder-actuated tools’ includes a form of nail gun, arranged drive a nails (or other specialised fastenings) into a substrate. Well known examples of such tools include so called Hilti guns, manufactured by the Hilti Corporation, in which multiple nails and/or cartridges attached to strips of plastic tape are fed into the gun and propelled one after another into a substrate. The tools use a controlled explosion created by small chemical propellant charge.

Generally, such tools can be classed as ‘high velocity’, in which case the propellant acts directly on the nail/other fastener, or ‘low velocity’, in which a piston is arranged in a chamber between the propellant and the fastener. In such low velocity tools, the propellant acts on the piston, and this then drives the fastener into the substrate.

There are many uses of these tools, including large scale building projects and ship repairs, and such tools can also be found in many domestic settings. However, the tools are generally relatively bulky and heavy and therefore cumbersome to transport and use.

There remains a need to provide a lightweight alternative to existing versions of such tools, preferably combined with safety features and ease of use.

### SUMMARY OF THE INVENTION

According to a first aspect of the present invention there is provided a tool arranged to at least partially expel a projectile, wherein the tool comprises a housing having a primary axis, and, at least partially enclosed within the housing, (i) a firing mechanism and (ii) a projectile arranged to be at least partially expelled from the housing in a direction parallel to the primary axis on actuation of the firing mechanism,

wherein the firing mechanism comprises a chemical propellant and at least two moveable components, both of the components being moveable in a direction parallel to the primary axis within the housing, wherein

(i) the chemical propellant is arranged such that, when activated, the gases created thereby act to expel the projectile, and

(ii) the moveable components are arranged such that displacement of both components from a rest position is required to activate the propellant, and the components are moveable in response to a force applied directly along the primary axis.

Such a tool is a capable of providing a nail gun, centre punch or the like, in which the projectile is readily expelled, preferably along the primary axis, and preferably in response to external forces applied directly along the primary axis. In such a tool, all forces operate along a common axis (the primary axis), and the tool maybe actuated with relatively little force and complexity (compare the situation with using a trigger, in which the force is applied indirectly, via a pivot mounting or the like, to activate a firing mechanism).

The two movable components may be independently moveable. Activation of the propellant may be caused by the combination of movement of the first movable component in a first direction and movement of the second movable component in a second direction, wherein the second direction is generally opposite to the first direction.

In some embodiments, the projectile may be partially retained in the housing. This may therefore provide a means for fixing the housing to a substrate. The housing may thereafter advantageously act as a handhold, foot hold, or stopper, or the like.

In preferred embodiments, the projectile is a fastener, preferably a spiked and/or longitudinal fastener such as a nail. This is a highly versatile style of fastener which can be used with many different substrates.

In one example, the projectile may be arranged such that, prior to actuation, it protrudes from the housing, and further such that pressure applied to the protruding portion of the projectile acts to move one movable component into the position required for actuation of the propellant. Therefore, in such examples the tool may be actuated, in part, by pushing the tip of the projectile into or against the substrate, which may assist in accurately aligning the projectile with the substrate prior to actuation.

In preferred embodiments, the tool may be designed as a ‘single use’ tool. Such a feature is advantageous as it allows the design to be simple (there is no need to provide reloading or re-cocking features), and/or in that the materials used need not be robust enough to withstand multiple uses. For example, plastics, polymers, metals and the like which deform or buckle on actuation can be used, so long as they are sufficiently strong to contain the gas and allow the projectile to be ejected. Components made of such materials may be lighter and/or less expensive than components which are made of materials (or of sufficient material) designed to withstand repeated actuations. Further, the force required to actuate the tool may be contained within a closed cylinder, rather than a cylinder which requires re-loading from the side as is the case with conventional, cartridge fed nail guns, and therefore may be simpler to make.

In one embodiment, the movable components are arranged to slide or roll within the housing. In preferred embodiments, the sliding/rolling is constrained to be parallel to a track defined by the structure of the housing. This allows the tool have a simple structure and may help constrain movement to be parallel to the primary axis. In preferred embodiments, the movement is along the primary axis.

When in a rest position, the first movable component may partially protrude from a first end of the housing, and/or the second movable component may partially protrude from a second end of the housing. This exposes the components from the housing allowing for the ready application of force thereto.

In actuation of such a tool, the components may advantageously be caused to move towards one another.

In one preferred embodiment, the housing is substantially cylindrical (although this need not be a circular (or indeed regular) cylinder). The housing may preferably be dimensioned so as to be readily held in the hand of a user. Preferably, the tool comprises no substantial projections in direction(s) at an angle to the primary axis (e.g. trigger units and the like). Such a tongitundinal or baton-like form may make the device easy to carry. When in a rest position, the first movable component may partially protrude from the first end of the cylindrical housing, and the second movable component may partially protrude from the second end of the cylindrical housing. This provides a firing mechanism in line with the primary axis, which does not add substantial bulk and allows the tool to be compact.

In some examples, the first and second movable components are urged into the rest position by biasing apparatus. The biasing apparatus may comprise one or more resilient members such as springs, rubber or elastic components or the like. Alternatively or additionally there may be further apparatus or design features to hold the components in the rest (or other given) position, including one or more of the following: a locking pin securing one or both movable components, a compressible member, such as an O-ring or the like, or a high-friction material, arranged between one or more movable component and the housing and further arranged to resist movement once placed in the rest (or other given) position, and/or provision of an interference fit between one or both components and the housing.

In preferred embodiment, the tool further comprises a slide hammer which capable of sliding in a direction parallel to the primary axis of the housing, and in turn acts on the projectile. Alternatively, the gasses may act directly to expel the projectile. In either case, the projectile/slide hammer may be contained within a barrel arranged to receive the gases generated by the propellant. Preferably the barrel comprises exhaust ports arranged to allow the gasses to expel once the slide hammer/projectile has travelled sufficiently under the action of the gas.

In preferred embodiments, the propellant is arranged in a percussive firing cap. This is advantageous as it reduces the chance of the tool being actuated accidentally, as only sharp percussive actions will result in activation of the propellant.

The invention is also directed to methods by which the described apparatus operates and including method steps for carrying out every function of the apparatus.

For example, according to one aspect of the invention, there is provide a method of fixing an item to a substrate, the method comprising (i) providing a tool according to the first aspect of the invention, (ii) positioning the tool such that, when expelled therefrom, the projectile will fix the item to the substrate and (iii) applying a force to both of said movable members along the primary axis of the tool.

This provides a highly versatile, simple fixing method. The item may, for example, be a strip item, such as a rope, tape or cord, or may be fixing such as a metal plate, or a mounting means such as a base plate, or indeed comprise any item capable of being penetrated or secured by the projectile. The substrate may be stone, concrete, wood, metal, plastic, plaster, fabric, or indeed any type of substrate which may be penetrated by the projectile (which may be chosen accordingly).

In preferred embodiments, in which one of the moveable components is moved by applying force to one end of the tool, the step of positioning the tool and the step of applying a force to at least one of said movable members may comprise a single step.

According to a further aspect of the invention, there is provided a method of fixing a projection to a substrate, wherein the projection comprises the housing of the tool of the first aspect of the invention, the method comprising (i) providing a tool according to the first aspect of the invention in which the projectile is only partially ejected from the housing, (ii) positioning the tool such that, when expelled therefrom, the projectile will fix the housing to the substrate, and (iii) applying a force to both of said movable members along the primary axis of the tool.

According to a further aspect of the invention, there is a provided a single use powder actuated tool arranged to at least partially expel a projectile, wherein the tool comprises a housing having a primary axis, and, at least partially enclosed within the housing, (i) a firing mechanism and (ii) a projectile arranged to be at least partially expelled from the housing in a direction parallel to the primary axis on actuation of the firing mechanism, wherein the firing mechanism comprises a chemical propellant.

The single use tool may have any of the features of the tool discussed in relation to the first aspect of the invention.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 shows an assembled nail gun according to one embodiment of the invention;

FIG. 2 shows an exploded view of the components within the nail gun of FIG. 1;

FIGS. 3 & 4 show a view of some of internal components of the nail gun of FIG. 1;

FIG. 5 shows an assembled nail gun according to a second embodiment of the invention; and

FIGS. 6-8 show a view of some of internal components of the nail gun of FIG. 5.

### DETAILED DESCRIPTION OF INVENTION

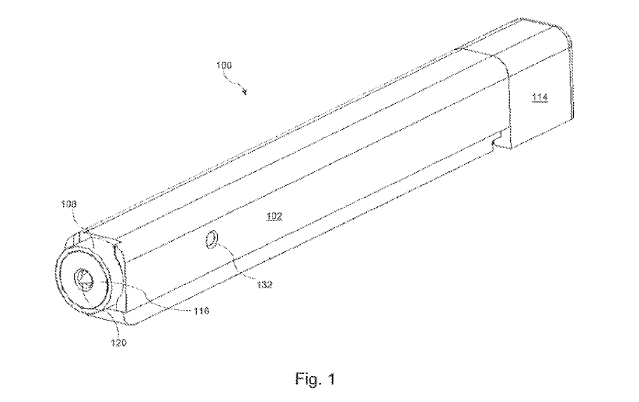

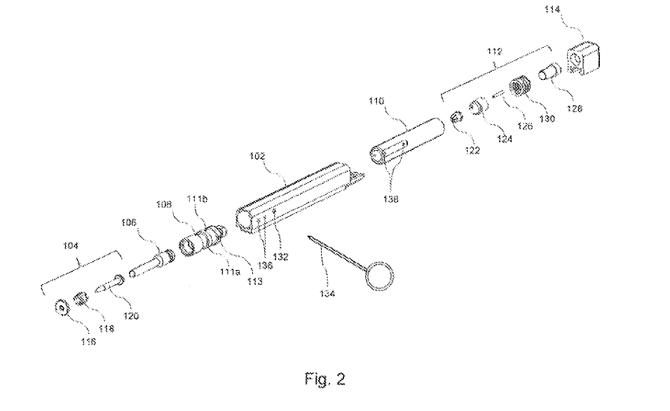

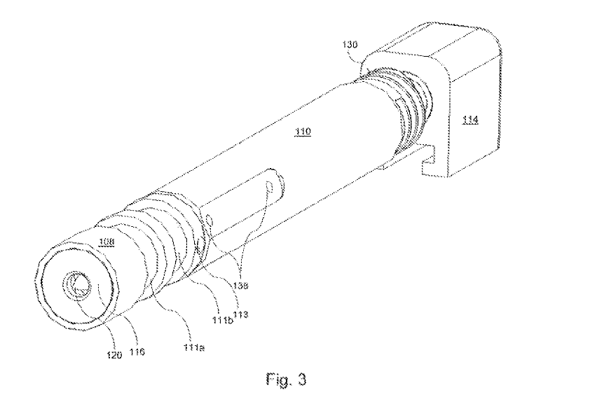

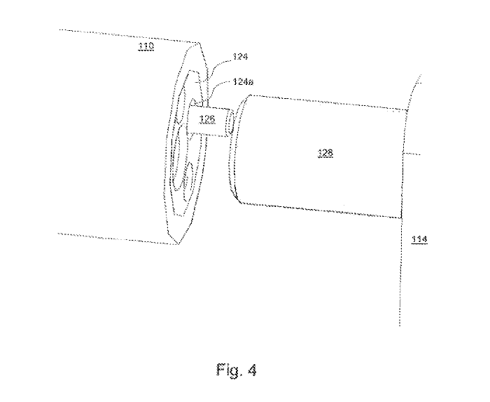

FIG. 1 shows an assembled ‘single shot’ nail gun tool according to one embodiment of the invention. The internal components are shown in an exploded view in FIG. 2, and various components, assembled or partly assembled, are shown in FIGS. 3 and 4, as explained in greater detail below.

With reference then to FIGS. 1-4, a nail gun tool 100 according to one embodiment of the invention has a generally elongate cylindrical body sized to be held inside the hand of a user which comprises an outer housing 102, which in this example comprises 5083 N8 Aluminium, but in other examples could comprise a composite material (in particular but not exclusively reinforced plastic or polymer composites), moulded plastic or even rolled cardboard. Inside the housing 102 are a nail assembly 104, a slide hammer 106, a cylinder 108, a barrel 110, a firing assembly 112, and an end block 114. In this example, the barrel 110 comprises steel (specifically EN24 Steel), but other materials which are capable of withstanding the expansion of gases from the firing assembly 112 could be used. The slide hammer 106 in this example is made of heat treated mild steel, but one alternative is machinable grade Tungsten, and other alternatives will occur to the skilled person. The cylinder 108 may be made from, for example, brass, 6083 aluminium, or injection moulded from glass filled nylon or made of other materials. Alternative materials may include composite materials, particularly wound composites.

The nail assembly 104 comprises a washer 116, a spacer 118 (which in this example is a nylon spacer), and a projectile in the form of a nail 120. In this example, when the tool 100 is ready for use, the spacer 118 and the washer 116 are placed as collars around the nail 120, the spacer 118 sitting between head of the nail 120 and the washer 116. The spacer 118 in this example is a plastic component which is crushed or cracks off on actuation of the tool 100. The skilled person may be aware of such nail assemblies from existing nail gun tools and the like.

When assembled, the nail assembly 104 is held within the cylinder 108, which is itself is fixed (in this example, screwed) to the end of the barrel 110. Also within the barrel 110 is the slide hammer 106, which acts directly on the nail 120 when the tool 100 is activated, as will be described in greater detail below. However, in this example, the slide hammer 106 is generally held static within the barrel 110 until activation occurs through use of an O-ring placed around the head of the slide hammer 106 (not shown), which prevents it from moving until a force above a threshold value is applied. The cylinder 108 also comprises a through-hole 113 arranged to receive a locking pin as detailed below. Of course, other methods of restricting the movement of the slide hammer 106 will occur to the skilled person, such as making it an interference fit within the barrel 110. Further, as can be best seen from FIG. 3, the cylinder 108 comprises two circumferential channels 111a, 111b, each approximate 5 mm in width, the function of which is expanded upon below.

The firing assembly 112 is arranged in the opposite end of the barrel 110 to the nail assembly 104 and comprises a percussion cap 122 (which in this example is a commercially available chemical propellant charge, comprising “gun powder priming composition”, known as Sinoxyd, which is a combination of Nitro Cellulose and Nitro Glycerine, but alternatives will occur to the skilled person). The percussion cap 122 is secured within the barrel 110 by a breech block 124. The breech block 124 is screwed into the top of the barrel 110, holding the cap 122 in position but not exerting excessive pressure. As is best shown in FIG. 4, the breech block 124 comprises a hole 124a, through which a firing pin 126 may be inserted. The firing pin 124 is arranged such that, on actuation of the tool 100 once ready for use, it can impact the percussion cap 122 and cause it to fire. The firing pin 124 itself is acted on by a hammer block 128, which is generally held at a spaced distance from the firing pin 124 by the action of a spring 130 (which is not shown in FIG. 4, but can be seen in FIGS. 2 and 3). Therefore, the firing pin 126 in conjunction with the hammer block 128 provide a movable component which act as part of the firing mechanism.

The end of the hammer block 128 sits in a recess within the end block 114, but is free to move therein against the action of the spring 130. The spring 130 urges the hammer block 128 such that it tends to protrude from the end of the tool 100 (in alternative examples, it may be held flush with the end until a locking pin is removed).

In this example, the breach block 124 is mild steel, the firing pin 126 is tool steel, the cap end of the hammer block 128 could be aluminium but advantageously be of a heavier material such as steel, stainless steel or brass.

As can be seen from FIGS. 1 and 2, the outer housing 102 comprises a locking pin hole 132. Although not shown, a similar hole is found in the parallel face of the outer housing 102. This hole 132 is arranged to receive a locking pin 134, which also passes through the through hole 113 in the cylinder 108. Once this pin 134 is removed, the barrel 110 is able to move inside the housing 102 (although is generally held in place by the O-ring, as described above). The outer housing 102 further comprises two screw holes which receive two screws 136, which in this example are 3 mm screws. These screws 136 can be positioned to protrude into the interior of the housing 102 and interact with the channels 111a, 111b on the cylinder 108 to limit its travel in the manner set out below.

When assembled, with the pin 134 in place, the nail tip and the cylinder 108 slightly protrude from one end of the housing 102 while the hammer block 128 slightly protrudes from the other end. The screws 136 are screwed into the housing such that they lie in the channels 111a, 111b but do not otherwise interfere with the cylinder 108. This allows a spacing of, in this embodiment, around 4 mm between the firing pin 126 and the cap 122. This gap can be reduced by pressing on both the nail end and the end block 114 end of the tool 100, such that the cylinder 108 and the hammer block 128 are respectively urged together and are pushed inside the housing 102. Of course, as the cylinder 108 is screwed to the barrel 110, into which are fixed the firing cap 122 and the breech block 124, and therefore these parts are also pushed back towards the end cap 114, against the action of the spring 130. Therefore, the nail assembly together with the cylinder 108, the barrel 110, firing cap 122 and breech block 124 provide a moveable component which act as part of the firing mechanism.

In this exemplary embodiment, the barrel 110 is free to travel around 2 mm before the screws 136 hit the edges of the channels 111a, 111b, which are nominally 5 mm wide, and therefore constrain the slide action to a little over 2 mm. The remaining approximately 2 mm spacing between firing pin 126 and the firing cap 122 can be closed by pushing on the hammer block 128, which moves the pin 126 towards the firing cap 122 against the action of the spring 130. Although not visible in the figures, an additional screw similar to the screws 136 described above is provided to limit the slide action of the hammer block 128 to around 2 mm. If the pin 126 exerts sufficient force on the cap 122, then firing will occur.

This arrangement means that movement is required from both ends to affect the firing. No firing can occur while the locking pin 134 is in place, or unless pressure is exerted on both the nail end and the hammer block end of the tool 100, providing displacement of components from their rest positions in opposite directions. It will be noted that the spring 130 that pushes out the barrel 110 also pushes out the hammer block 128, so holding both the nail assembly 104 and the hammer block 128 in their rest positions, in which they partially protrude from the substantially cylindrical housing. If the block 128 is hit with the barrel 110 still protruding from the housing, there is not enough travel in the block 128 to impact the firing pin 126 so no firing takes place. Only once the barrel 110 has been pushed back and the hammer block 128 struck will the firing pin 126 move enough to activate the cap 122.

Of course, other ways of limiting the travel of the components to ensure that firing cannot be effected from interaction with one end of the tool 100 only will occur to the skilled person.

It will also be noted that the barrel 110 comprises two exhaust ports 138, the function of which is explained in greater detail below.

In use therefore, the nail end of the tool 100 is preferably impacted against a substrate with a sharp blow, while a user applies pressure, with the palm of a hand or a hammer or other striking tool, for example, to the end block 114. In one example, the tool 100 is held with the palm of a user's hand over the hammer block 128 end and the safety pin 134 removed. The two parts of the assembly are able to move within the housing 102 but held apart by the spring 130. Driving the head of the tool 100 into an immoveable object (which could be any substrate, such as wood, metal, concrete, earth, etc.) initially causes the nose of the tool 100 to stop allowing the housing 102 to continue in motion effectively closing up the gap towards the cap 122. At the same time the housing 102 is sliding forward and the hammer bock 128 is held in the forward position by the user's hand, allowing the firing pin 124 to impact the cap 122 and the tool 100 fires.

In the event that the cap 122 fails to fire, the user could hold the tool 100 in place and attempt firing by striking the back of the tool 100, for example with their hand or a hammer or other striking tool.

The firing of the cap 122 causes gases to be created, forcing the sliding hammer 106 to move along inside the barrel 110 until it impacts the nail head located in the cylinder 108. On impact, the nail 120 is driven forward into the substrate along a primary axis of the tool 100 (which in this example is the longitudinal axis). When the slide hammer 106 reaches its full travel, it has moved down in barrel 110 such that its head is past the two exhaust ports 138. This allows the gases to vent from the barrel 110.

It will be noted that all significant forces (i.e. the forces applied by the user and the forces applied in firing) act directly along a longitudinal axis of the tool 100. Moreover, a single impact can serve both to ‘prime’ the tool 100 (by repositioning the barrel 110 and percussion cap 122 closer to the firing pin 126), and to fire the tool 100. This means that the tool 100 can be actuated one-handed once the pin 134 has been removed, as it is a single movement in one direction (albeit abruptly stopped) which causes actuation through the application of external force directly along the axis of the tool 100. This simple action is aided by the fact that the same spring 130 acts as part of a priming mechanism (i.e. is compressed when the tip of the nail 120 is pressed against a surface) and the firing mechanism (it will be noted that these roles can be exchanged, with the nose effecting firing), which also allows the tool to be simple in structure. It also means the device may be small: there is no need for a separate trigger, and no need to laterally transfer pressure exerted on a trigger. It also means that forces may be minimised, as they act only in a fully enclosed space, and only along one axis.

For some variants, the head of the nail 120 is retained within the end of the cylinder 108 by the washer 116. This means that the housing 102 and end block 114 will protrude from the substrate, while being attached thereto. This can therefore act as a hand-hold, ladder rung, or a blocker (for example, a nail could be driven into the ground inside the path of a door, preventing its opening or closing, or in the travel of sash window, restricting its movement). However, this need not be the case in all embodiments and, even if the projectile is not fully expelled, the body of the tool 100 may be removable: for example broken or screwed off, leaving a small or minimal part.

In this example, however, as in conventional nail guns, the nail 120 leaves the tool 100 completely, taking the washer 116 along with it. The washer 116 therefore also helps to secure an item to a substrate (this may be useful if the item is, for example, woven, such that there is a risk it could be pulled past a relative small nail head). In one example, there may be a deformable element which generally retains the nail but is deformed on firing. This could be replaced, or the device could be a ‘single shot’ device.

The single use nature of the apparatus means that there is no need to be able to reload (with nails or with explosives) or re-cock the device, simplifying the design. This in turn means that materials need to be robust to withstand firing without warping (albeit that the device is preferably safe to hold without protective gloves or the like).

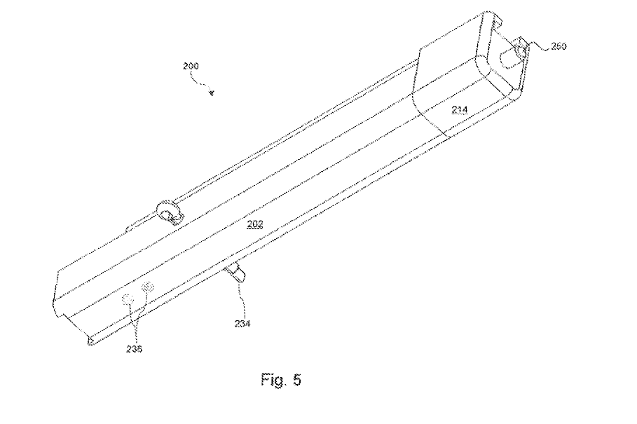

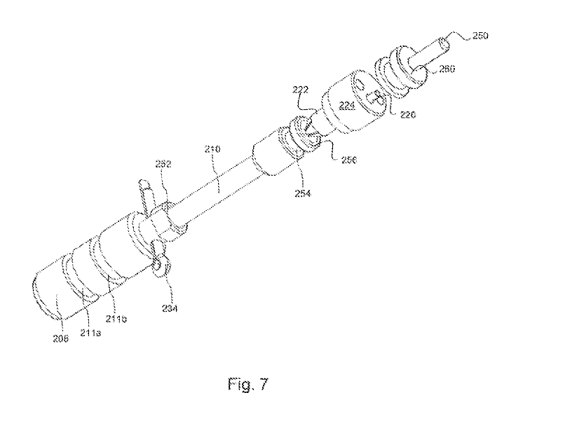

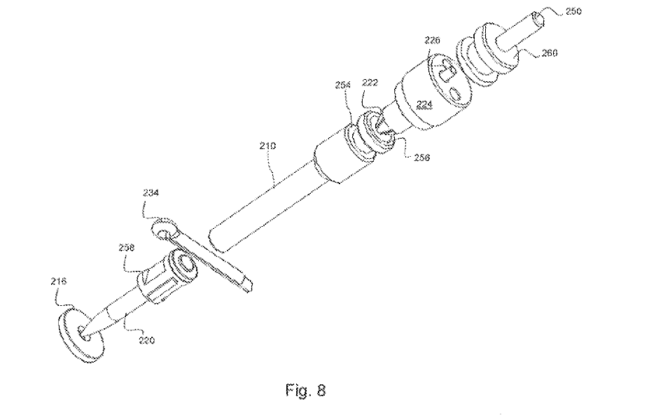

A second embodiment of a tool 200 according to the invention is now described with reference to FIGS. 5 to 8. In these Figures, features in common with the embodiment described above are indicated by the numerals used above, plus 100. Thus the firing cap is designated 122 in relation to the first embodiment and 222 in relation to the second embodiment and so on. Unless mentioned below, the features operate as described above.

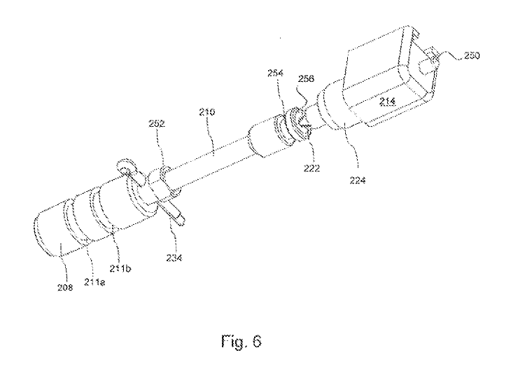

FIG. 6, illustrates how the slide hammer 210 is shown partially inserted into an end portion 252 of the barrel 208, which therefore serves to guide the hammer 210 as it moves. It will also be noted that the slide hammer incorporates a groove 254, which may receive a sealing O ring if required, acting to seal the space between the end of the slide hammer 210 and the barrel (not shown in FIGS. 5 to 8, but similar to that shown in relation to the first embodiment described above). The hammer 210 is also shown with a concave head portion 226, which captures and directs the gas jet from the cap 222.

The end block 214 in this embodiment comprises a protruding button 250, mounted on a ribbed mounting block 260. This arrangement comprises less material than the hammer block 128 in the first embodiment of the invention and may therefore save on materials and/or weight where such factors are a concern. However, where this portion of the tool 200 is lighter, it may also require a greater striking force from the user as it will carry less momentum.

Further, the nail assembly includes a deforming stopper 258, which acts to keep the nail aligned with the axis of the tool 200 during firing, and then deforms when the tool 200 is fired, flattening to ensure the nail does not pass through the washer 216. Such a stopper may be familiar to the skilled person from known nail gun tools. In this example, the washer 216 is too large to leave the tool 200, and therefore the housing 202 is held to a substrate into which the nail 220 is fired.

Although not shown in the Figures, the tool 200 comprises at least one spring arranged between the breech block 224 and the mounting 260 to urge the tip of the nail 220 and the protruding button 250 components to protrude from the housing 202.

Any range or device value given herein may be extended or altered without losing the effect sought, as will be apparent to the skilled person for an understanding of the teachings herein. In addition, the skilled person may choose materials which are suited to the intended use (for example, both the explosive charge and the nail strength may be less if the tool is to be used for attaching times to wood as supposed to concrete or stone). The projectile is in this example a nail, but need not be so. Alternative devices, for example other fixings such as staples or the like, could be used. Although the above embodiments comprise slide hammers, that need not be the case and the gases could act directly on a projectile.

1. A tool arranged to at least partially expel a projectile, comprising:
a housing having a primary axis, the projectile being at least partially enclosed within the housing; and
a firing mechanism at least partially enclosed within the housing, the projectile being arranged to be at least partially expelled from the housing in a direction parallel to the primary axis on actuation of the firing mechanism, the firing mechanism including a chemical propellant and at least two moveable components, both of the components being moveable in a direction parallel to the primary axis within the housing, wherein:
(i) the chemical propellant is arranged such that, when activated, the gases created thereby act to expel the projectile, and
(ii) the moveable components are arranged such that displacement of both components from a rest position is required to activate the propellant, and the components are moveable in response to a force applied directly along the primary axis.

2. The tool according to claim 1, wherein the projectile is partially retained in the housing after firing.

3. The tool according to claim 1, wherein the projectile is arranged such that, prior to use of the tool, it partially protrudes from the housing.

4. The tool according to claim 3, wherein the tool is arranged such that pressure applied to the protruding portion of the projectile acts to move one movable component into the position required.

5. The tool according to claim 1, wherein the tool is powder actuated and is a single use tool.

6. The tool according to claim 5, wherein the tool is at least partially formed of materials which deform or buckle on actuation.

7. The tool according to claim 1, wherein the movable components are arranged to slide or roll within the housing.

8. The tool according to claim 7, wherein the sliding/rolling is constrained to be parallel to a track defined by the structure of the housing.

9. The tool according to claim 1, wherein, prior to actuation, the first movable component partially protrudes from a first end of the housing, and/or the second movable component partially protrudes from a second end of the housing.

10. The tool according to claim 1, wherein, in actuation of the tool, the components are be caused to move towards one another.

11. The tool according to claim 1, wherein the housing is substantially cylindrical.

12. The tool according to claim 1, wherein the housing is arranged to be held in a user's hand.

13. The tool according to claim 1, wherein the first and second movable components are urged into the rest position by biasing apparatus.

14. The tool according to claim 1, wherein the first and second movable components are held in the rest position.

15. The tool according to claim 1, further comprising a slide hammer which is capable of sliding in a direction parallel to the primary axis of the housing, and in turn acts on the projectile.

16. The tool according to claim 1, further comprising a barrel arranged to receive the gases generated by the propellant.

17. The tool according to claim 16, further comprising exhaust ports arranged to allow the gasses to expel once the projectile has been at least partially ejected.

18. The tool according to claim 1, wherein the propellant is provided in a percussive firing cap.

19. A method of fixing an item to a substrate, the method comprising:
providing the tool of claim 1;
positioning the tool such that, when expelled therefrom, the projectile will fix the item to the substrate; and
applying a force to both of said movable members along the primary axis of the tool.

20. The method according to claim 19, further comprising moving one of the moveable components by applying force to one end of the tool, and the step of positioning the tool and the step of applying a force to at least one of said movable members may include a single step.

21. A method of fixing a projection to a substrate, wherein the projection includes the housing of the tool of claim 2, the method comprising:
providing the tool of claim 2;
positioning the tool such that, when expelled therefrom, the projectile will fix the housing to the substrate; and
applying a force to both of said movable members along the primary axis of the tool.

22. (canceled)
